(19) United States
(12) Patent Application Publication
(10) Pub. No.: US 2023/0324751 A1
(43) Pub. Date: Oct. 12, 2023

(54) DISPLAY DEVICE

(71) Applicant: Japan Display Inc., Tokyo (JP)

(72) Inventors: Yoshihide OHUE, Tokyo (JP); Kentaro OKUYAMA, Tokyo (JP); Hiroki SUGIYAMA, Tokyo (JP); Yuuji OOMORI, Tokyo (JP); Koji KITAMURA, Tokyo (JP)

(21) Appl. No.: 18/296,470

(22) Filed: Apr. 6, 2023

(30) Foreign Application Priority Data
Apr. 8, 2022 (JP) 2022-064758

(51) Int. Cl. G02F 1/1362; G02F 1/1368

(52) U.S. Cl. CPC G02F 1/136286; G02F 1/1368

(57) ABSTRACT

A display device includes: an array substrate; a counter substrate; a liquid crystal layer between the array substrate and the counter substrate; spacers regulating a distance between the array substrate and the counter substrate; and a light source. The array substrate includes: signal lines arranged in a first direction; scan lines arranged in a second direction; switching elements each of which is coupled to a corresponding scan line and a corresponding signal line; and an organic insulating layer covering at least the switching elements. An area surrounded by the scan lines and the signal lines has a second area having a thickness less than that of the organic insulating layer in a first area overlapping the switching elements, the scan lines, and the signal lines in plan view. The spacers arranged in the first area have a thickness less than that of the organic insulating layer in the first area.

### CROSS-REFERENCE TO RELATED APPLICATION

This application claims the benefit of priority from Japanese Patent Application No. 2022-064758 filed on Apr. 8, 2022, the entire contents of which are incorporated herein by reference.

### BACKGROUND

### 1. Technical Field

What is disclosed herein relates to a display device.

### 2. Description of the Related Art

Japanese Patent Application Laid-open Publication No. 2018-021974 (JP-A-2018-021974) describes a display device including a first light-transmitting substrate, a second light-transmitting substrate disposed so as to face the first light-transmitting substrate, a liquid crystal layer including polymer-dispersed liquid crystals filled between the first light-transmitting substrate and the second light-transmitting substrate, and at least one light emitter disposed so as to face at least one of side surfaces of the first light-transmitting substrate and the second light-transmitting substrate.

In the display device described in JP-A-2018-021974, an area surrounded by scan lines and signal lines has a bathtub area in which an insulating layer has a thickness less than the thickness of the signal lines and the insulating layer overlapping the scan lines in plan view. When monomers are polymerized to form a polymer network, this polymer network is fluid and floats in a liquid crystal layer. Therefore, for example, a point press or a drop impact on a screen of a display panel moves the polymer network of the liquid crystal layer in the bathtub area to adjacent pixels irreversibly, in some cases. This movement causes alignment characteristics of liquid crystal molecules to be different pixel by pixel, in some cases. When the alignment characteristics are different pixel by pixel, the degree of transmittance is caused to be different pixel by pixel, thereby possibly degrading display quality.

For the foregoing reasons, there is a need for a display device that improves the display quality.

### SUMMARY

According to an aspect, a display device includes: an array substrate; a counter substrate; a liquid crystal layer between the array substrate and the counter substrate; spacers that regulate a distance between the array substrate and the counter substrate; and a light source disposed so as to emit light into a side surface of the array substrate or a side surface of the counter substrate. The array substrate includes: signal lines arranged in a first direction with spaces interposed between the signal lines; scan lines arranged in a second direction with spaces interposed between the scan lines; switching elements each of which is coupled to a corresponding one of the scan lines and a corresponding one of the signal lines; and an organic insulating layer that covers at least the switching elements. An area surrounded by the scan lines and the signal lines has a second area having a thickness less than that of the organic insulating layer in a first area that overlaps the switching elements, the scan lines, and the signal lines in plan view. The spacers arranged in the first area have a thickness less than that of the organic insulating layer in the first area.

### BRIEF DESCRIPTION OF THE DRAWINGS

FIG. 1 is a perspective view illustrating an example of a display device according to an embodiment of the present disclosure;

FIG. 2 is a block diagram illustrating the display device of a first embodiment of the present disclosure;

FIG. 3 is a timing diagram explaining timing of light emission by a light source in a field-sequential system of the first embodiment;

FIG. 4 is an explanatory diagram illustrating a relation between a voltage applied to a pixel electrode and a scattering state of a pixel;

FIG. 5 is a sectional view illustrating an example of a section of the display device of FIG. 1;

FIG. 6 is a plan view illustrating a planar surface of the display device of FIG. 1;

FIG. 7 is an enlarged sectional view obtained by enlarging a liquid crystal layer portion of FIG. 5;

FIG. 8 is a sectional view illustrating a state before monomers in the liquid crystal layer are polymerized;

FIG. 9 is a sectional view for explaining the scattering state in the liquid crystal layer;

FIG. 10 is a plan view illustrating scan lines, signal lines, and a switching element in the pixel;

FIG. 11 is a plan view illustrating a holding capacitance layer in the pixel;

FIG. 12 is a plan view illustrating an auxiliary metal layer and an opening area in the pixel;

FIG. 13 is a plan view illustrating the pixel electrode in the pixel;

FIG. 14 is a plan view illustrating a light-blocking layer in the pixel;

FIG. 15 is a sectional view along XV-XV′ of FIG. 14;

FIG. 16 is a sectional view along XVI-XVI′ of FIG. 14;

FIG. 17 is a sectional view along XVII-XVII′ of FIG. 14;

FIG. 18 is a sectional view of a peripheral area;

FIG. 19 is a plan view illustrating a shape and positions of spacers in the display device according to a second embodiment of the present disclosure;

FIG. 20 is a plan view illustrating shapes and positions of spacers in the display device according to a third embodiment of the present disclosure; and

FIG. 21 is a plan view illustrating the scan lines, the signal lines, and switching elements in the pixels according to a fourth embodiment of the present disclosure.

### DETAILED DESCRIPTION

The following describes modes (embodiments) for carrying out the present disclosure in detail with reference to the drawings. The present disclosure is not limited to the description of the embodiments given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

In this disclosure, when an element is described as being “on” another element, the element can be directly on the other element, or there can be one or more elements between the element and the other element.

### First Embodiment

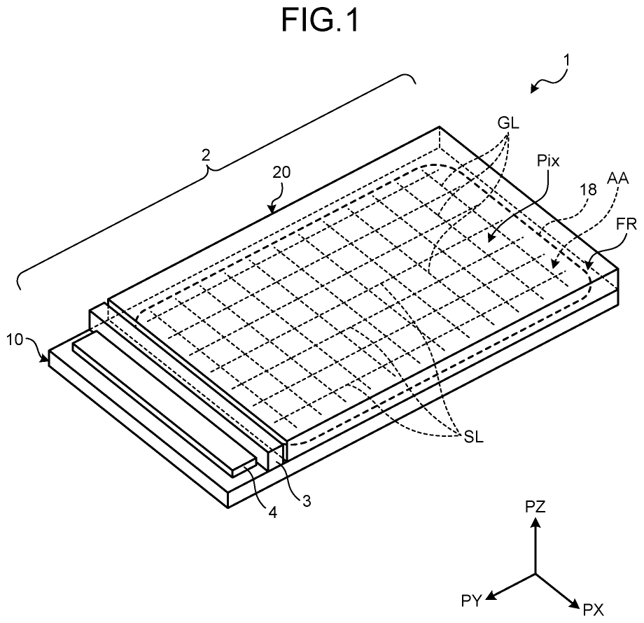

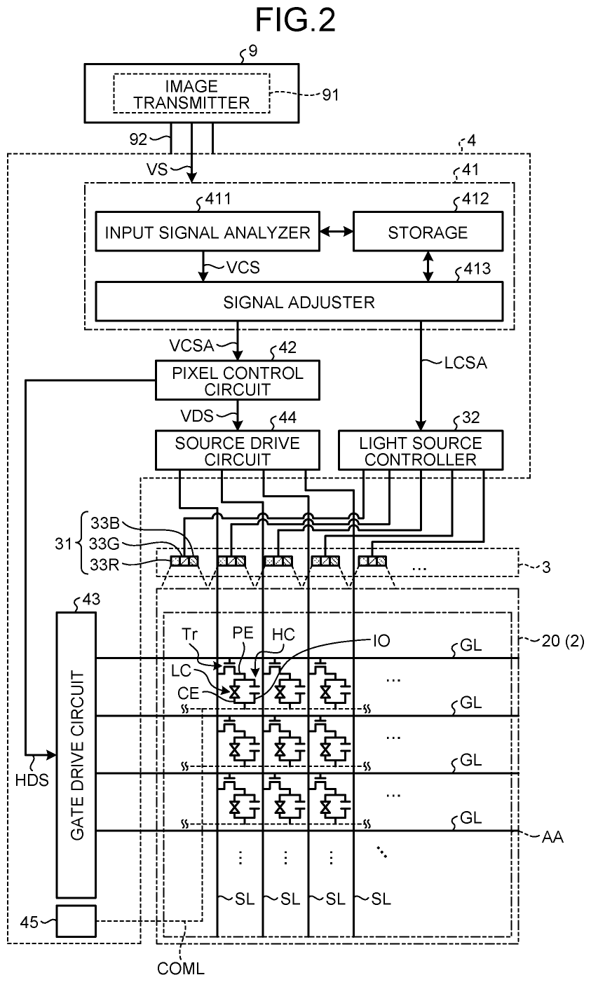

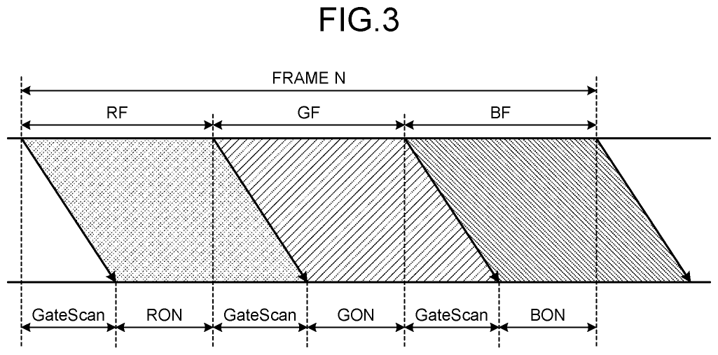

FIG. 1 is a perspective view illustrating an example of a display device according to a first embodiment of the present disclosure. FIG. 2 is a block diagram illustrating the display device of FIG. 1. FIG. 3 is a timing diagram explaining timing of light emission by a light source in a field-sequential system.

As illustrated in FIG. 1, a display device 1 includes a display panel 2, a light source 3, and a drive circuit 4. A first direction PX denotes one direction in the plane of the display panel 2. A second direction PY denotes a direction orthogonal to the first direction PX. A third direction PZ denotes a direction orthogonal to the PX-PY plane.

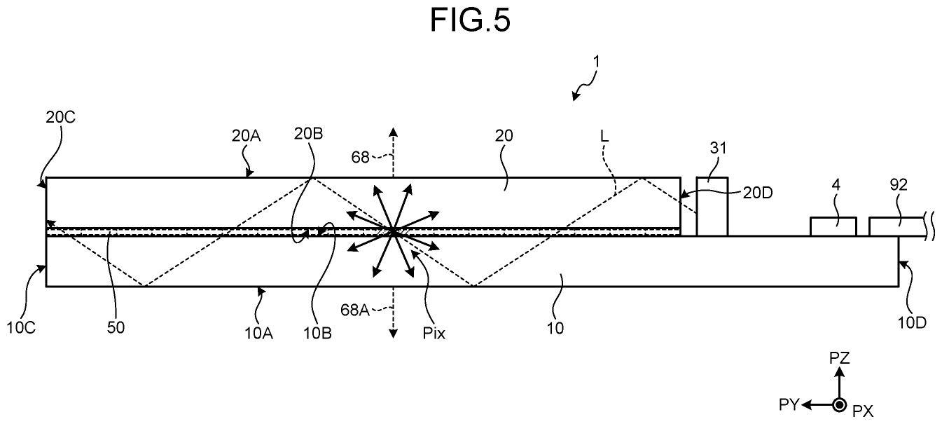

The display panel 2 includes an array substrate 10, a counter substrate 20, and a liquid crystal layer 50 (refer to FIG. 5). The counter substrate 20 faces a surface of the array substrate 10 in a direction orthogonal thereto (in the direction PZ illustrated in FIG. 1). In the liquid crystal layer 50 (refer to FIG. 5), polymer-dispersed liquid crystals LC (to be described later) are sealed by the array substrate 10, the counter substrate 20, and a sealing portion 18.

As illustrated in FIG. 1, the display panel 2 has a display area AA capable of displaying images and a peripheral area FR outside the display area AA. A plurality of pixels Pix are arranged in a matrix having a row-column configuration in the display area AA. In the present disclosure, a row refers to a pixel row including m pixels Pix arranged in one direction. In addition, a column refers to a pixel column including n pixels Pix arranged in a direction orthogonal to the direction in which the rows extend. The values of m and n are defined depending on a display resolution in the vertical direction and a display resolution in the horizontal direction. A plurality of scan lines GL are provided corresponding to the rows, and a plurality of signal lines SL are provided corresponding to the columns.

The light source 3 includes a plurality of light emitters 31. As illustrated in FIG. 2, a light source controller (light source control circuit) 32 is included in the drive circuit 4. The light source controller 32 may be a circuit separate from the drive circuit 4. The light emitters 31 are electrically coupled to the light source controller 32 through wiring in the array substrate 10.

As illustrated in FIG. 1, the drive circuit 4 is fixed to the surface of the array substrate 10. As illustrated in FIG. 2, the drive circuit 4 includes a signal processing circuit 41, a pixel control circuit 42, a gate drive circuit 43, a source drive circuit 44, and a common potential drive circuit 45. The array substrate 10 has an area in a PX-PY plane larger than that of the counter substrate 20, and the drive circuit 4 is provided on a projecting portion of the array substrate 10 exposed from the counter substrate 20.

The signal processing circuit 41 receives a first input signal (such as a red-green-blue (RGB) signal) VS from an image transmitter 91 of an external host controller 9 through a flexible substrate 92.

The signal processing circuit 41 includes an input signal analyzer 411, a storage 412, and a signal adjuster 413. The input signal analyzer 411 generates a second input signal VCS based on an externally received first input signal VS.

The second input signal VCS is a signal for determining a gradation value to be given to each of the pixels Pix of the display panel 2 based on the first input signal VS. In other words, the second input signal VCS is a signal including gradation information on the gradation value of each of the pixels Pix.

The signal adjuster 413 generates a third input signal VCSA from the second input signal VCS. The signal adjuster 413 transmits the third input signal VCSA to the pixel control circuit 42, and transmits a light source control signal LCSA to the light source controller 32. The light source control signal LCSA is a signal including information on light quantities of the light emitters 31 set in accordance with, for example, input gradation values given to the pixels Pix. For example, the light quantities of the light emitters 31 are set smaller when a darker image is displayed. When a brighter image is displayed, the light quantities of the light emitters 31 are set larger.

The pixel control circuit 42 generates a horizontal drive signal HDS and a vertical drive signal VDS based on the third input signal VCSA. In the present embodiment, since the display device 1 is driven based on the field-sequential system, the horizontal drive signal HDS and the vertical drive signal VDS are generated for each color emittable by the light emitter 31.

The gate drive circuit 43 sequentially selects the scan lines GL of the display panel 2 based on the horizontal drive signal HDS during one vertical scan period. The scan lines GL can be selected in any order.

The source drive circuit 44 supplies a gradation signal corresponding to the output gradation value of each of the pixels Pix to a corresponding one of the signal lines SL of the display panel 2 based on the vertical drive signal VDS during one horizontal scan period.

In the present embodiment, the display panel 2 is an active-matrix panel. For that reason, the display panel 2 includes the signal (source) lines SL extending in the second direction PY and the scan (gate) lines GL extending in the first direction PX in plan view, and includes switching elements Tr at intersecting portions between the signal lines SL and the scan lines GL.

A thin-film transistor is used as each of the switching elements Tr. A bottom-gate transistor or a top-gate transistor may be used as an example of the thin-film transistor. Although a single-gate thin film transistor is exemplified as the switching element Tr, the switching element Tr may be a double-gate transistor. One of the source electrode and the drain electrode of the switching element Tr is coupled to a corresponding one of the signal lines SL. The gate electrode of the switching element Tr is coupled to a corresponding one of the scan lines GL. The other of the source electrode and the drain electrode is coupled to one end of a capacitor of the polymer-dispersed liquid crystals LC to be described later. The capacitor of the polymer-dispersed liquid crystals LC is coupled at one end thereof to the switching element Tr through a pixel electrode PE, and coupled at the other end thereof to common potential wiring COML through a common electrode CE. Holding capacitance HC is generated between the pixel electrode PE and a holding capacitance electrode IO electrically coupled to the common potential wiring COML. A potential of the common potential wiring COML is supplied by the common potential drive circuit 45.

Each of the light emitters 31 includes a light emitter 33R of a first color (such as red), a light emitter 33G of a second color (such as green), and a light emitter 33B of a third color (such as blue). The light source controller 32 controls the light emitter 33R of the first color, the light emitter 33G of the second color, and the light emitter 33B of the third color so as to emit light in a time-division manner based on the light source control signal LCSA. In this manner, the light emitter 33R of the first color, the light emitter 33G of the second color, and the light emitter 33B of the third color are driven based on the field-sequential system.

As illustrated in FIG. 3, in a first sub-frame (first predetermined time) RF, the light emitter 33R of the first color emits light during a first color light emission period RON, and the pixels Pix selected during one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the first color is lit up during the first color light emission period RON.

Then, in a second sub-frame (second predetermined time) GF, the light emitter 33G of the second color emits light during a second color light emission period GON, and the pixels Pix selected during the one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the second color is lit up during the second color light emission period GON.

Further, in a third sub-frame (third predetermined time) BF, the light emitter 33B of the third color emits light during a third color light emission period BON, and the pixels Pix selected during the one vertical scan period GateScan scatter light to perform display. On the entire display panel 2, if the gradation signal corresponding to the output gradation value of each of the pixels Pix is supplied to the above-described signal lines SL for the pixels Pix selected during the one vertical scan period GateScan, only the third color is lit up during the third color light emission period BON.

Since a human eye has limited temporal resolving power and produces an afterimage, an image with a combination of three colors is recognized in a period of one frame (1F). The field-sequential system can eliminate the need for a color filter, and thus can reduce an absorption loss by the color filter. As a result, higher transmittance can be obtained. In the color filter system, one pixel is made up of sub-pixels obtained by dividing each of the pixels Pix into the sub-pixels of the first color, the second color, and the third color. In contrast, in the field-sequential system, the pixel need not be divided into the sub-pixels in such a manner. A fourth sub-frame may be further included to emit light in a fourth color different from any one of the first color, the second color, and the third color.

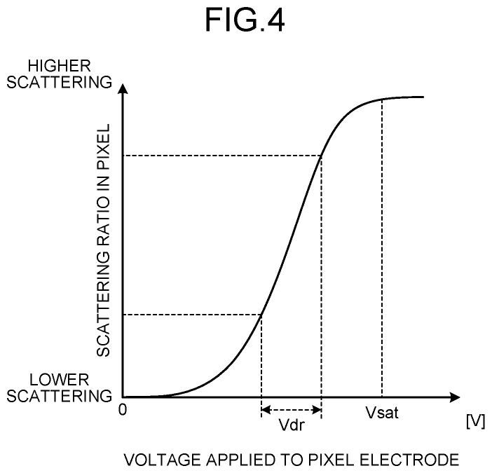

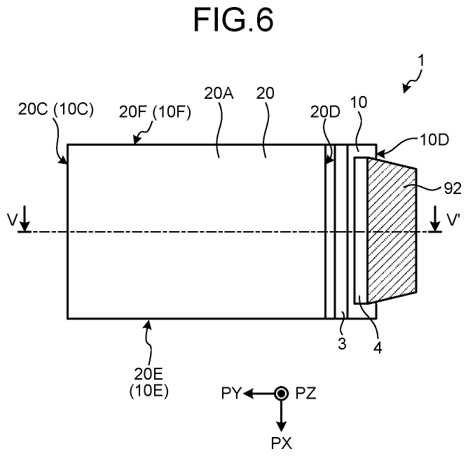

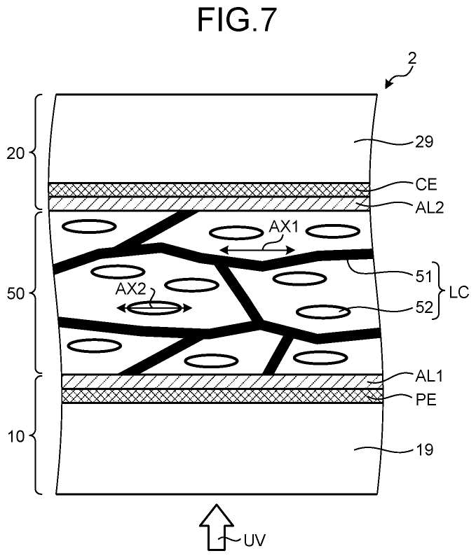

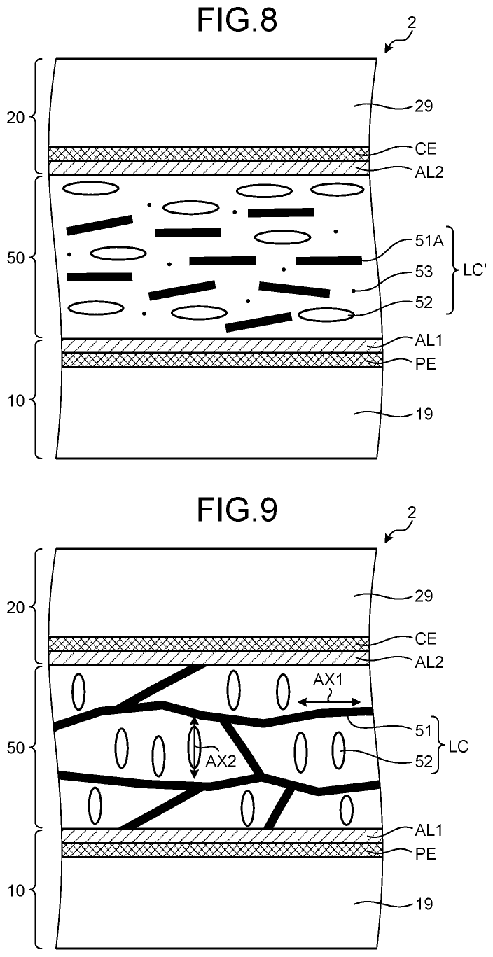

FIG. 4 is an explanatory diagram illustrating a relation between a voltage applied to the pixel electrode and a scattering state of the pixel. FIG. 5 is a sectional view illustrating an example of a section of the display device of FIG. 1. FIG. 6 is a plan view illustrating a planar surface of the display device of FIG. 1. FIG. 5 is a V-V′ sectional view of FIG. 6. FIG. 7 is an enlarged sectional view obtained by enlarging the liquid crystal layer portion of FIG. 5. FIG. 8 is a sectional view for explaining a non-scattering state in the liquid crystal layer. FIG. 9 is a sectional view for explaining the scattering state in the liquid crystal layer.

If the gradation signal corresponding to the output gradation value of each of the pixels Pix is supplied to the above-described signal lines SL for the pixels Pix selected during the one vertical scan period GateScan, a voltage applied to the pixel electrode PE changes with the gradation signal. The change in the voltage applied to the pixel electrode PE changes the voltage between the pixel electrode PE and the common electrode CE. The scattering state of the liquid crystal layer 50 for each of the pixels Pix is controlled in accordance with the voltage applied to the pixel electrode PE, and the scattering ratio in the pixels Pix changes, as illustrated in FIG. 4.

As illustrated in FIG. 4, the change in the scattering ratio in the pixel Pix is smaller when the voltage applied to the pixel electrode PE is equal to or higher than a saturation voltage Vsat. Therefore, the drive circuit 4 changes the voltage applied to the pixel electrode PE in accordance with the vertical drive signal VDS within a voltage range Vdr lower than the saturation voltage Vsat.

As illustrated in FIGS. 5 and 6, the array substrate 10 has a first principal surface 10A, a second principal surface 10B, a first side surface 10C, a second side surface 10D, a third side surface 10E, and a fourth side surface 10F. The first principal surface 10A and the second principal surface 10B are parallel flat surfaces. The first side surface 10C and the second side surface 10D are parallel flat surfaces. The third side surface 10E and the fourth side surface 10F are parallel flat surfaces.

As illustrated in FIGS. 5 and 6, the counter substrate 20 has a first principal surface 20A, a second principal surface 20B, a first side surface 20C, a second side surface 20D, a third side surface 20E, and a fourth side surface 20F. The first principal surface 20A and the second principal surface 20B are parallel flat surfaces. The first side surface 20C and the second side surface 20D are parallel flat surfaces. The third side surface 20E and the fourth side surface 20F are parallel flat surfaces.

As illustrated in FIGS. 5 and 6, the light source 3 faces the second side surface 20D of the counter substrate 20. The light source 3 may also be called a side light source. As illustrated in FIG. 5, the light source 3 emits light-source light L to the second side surface 20D of the counter substrate 20. The second side surface 20D of the counter substrate 20 facing the light source 3 serves as a plane of light incidence.

As illustrated in FIG. 5, the light-source light L emitted from the light source 3 propagates in a direction (second direction PY) away from the second side surface 20D while being reflected by the first principal surface 10A of the array substrate 10 and the first principal surface 20A of the counter substrate 20. When the light-source light L travels outward from the first principal surface 10A of the array substrate 10 or the first principal surface 20A of the counter substrate 20, the light-source light L enters a medium having a lower refractive index from a medium having a higher refractive index. Hence, if the angle of incidence of the light-source light L incident on the first principal surface 10A of the array substrate 10 or the first principal surface 20A of the counter substrate 20 is larger than a critical angle, the light-source light L is totally reflected by the first principal surface 10A of the array substrate 10 or the first principal surface 20A of the counter substrate 20.

As illustrated in FIG. 5, the light-source light L that has propagated in the array substrate 10 and the counter substrate 20 is scattered by the pixels Pix including the liquid crystals placed in the scattering state, and the angle of incidence of the scattered light becomes an angle smaller than the critical angle. Thus, emission light 68 and 68A are emitted outward from the first principal surface 20A of the counter substrate 20 and the first principal surface 10A of the array substrate 10, respectively. The emission light 68 or 68A emitted outward from the first principal surface 20A of the counter substrate 20 or the first principal surface 10A of the array substrate 10, respectively, is viewed by a viewer.

The following describes the array substrate 10, the counter substrate 20, and the liquid crystal layer 50 that constitute the display panel 2. FIG. 7 is an enlarged sectional view obtained by enlarging the liquid crystal layer portion of FIG. 5. FIG. 7 illustrates the liquid crystal layer after monomers are polymerized. FIG. 7 also illustrates the liquid crystal layer in the non-scattering state. FIG. 8 is a sectional view illustrating a state before the monomers in the liquid crystal layer are polymerized. FIG. 9 is a sectional view for explaining the scattering state in the liquid crystal layer.

As illustrated in FIG. 7, the array substrate 10 includes a first light-transmitting base member 19, the pixel electrode PE, and a first orientation film (orientation film) AL1. The counter substrate 20 includes a second light-transmitting base member 29, the common electrode CE, and a second orientation film (orientation film) AL2. The liquid crystal layer 50 is sealed between the first orientation film AL1 and the second orientation film AL2. The array substrate 10 may include a protective member (not illustrated) formed of, for example, glass, on a surface opposite to a surface of the first light-transmitting base member 19 on which the pixel electrode PE and the first orientation film (orientation film) AL1 are provided. The protective member may be made of a resin, as long as transmitting light. The counter substrate 20 may include a protective member (not illustrated) formed of, for example, glass, on a surface opposite to a surface of the second light-transmitting base member 29 on which the common electrode CE and the second orientation film (orientation film) AL2 are provided. The protective member may be made of a resin, as long as transmitting light.

The first light-transmitting base member 19 and the second light-transmitting base member 29 are formed of a light-transmitting material such as glass or polyethylene terephthalate. The pixel electrode PE and the common electrode CE formed of a light-transmitting conductive material such as indium tin oxide (ITO). The first and the second orientation films AL1 and AL2 cause liquid crystal molecules 52, which will be described later, in the liquid crystal layer 50 to be oriented in a predetermined direction and are formed of a light-transmitting orientation film material such as polyimide. An orientation treatment is applied to surfaces (surfaces to be in contact with the liquid crystal layer 50) of the first and the second orientation films AL1 and AL2 to form orientation films. In the present embodiment, for example, a rubbing treatment (rubbing orientation treatment) is applied to the surfaces (surfaces to be in contact with the liquid crystal layer 50) of the first and the second orientation films AL1 and AL2, whereby the first and the second orientation films AL1 and AL2 become horizontal orientation films. The rubbing treatment refers to rubbing the surfaces of the first and the second orientation films AL1 and AL2 with, for example, cloths along one direction to make the surfaces anisotropic so as to give the films a liquid crystal orientation. The orientation treatment is not limited to the rubbing treatment but may be a photo-orientation treatment in which the orientation treatment is performed by light irradiation.

As illustrated in FIG. 8, a solution LC′ containing pluralities of photocrosslinkable monomers 51A, the liquid crystal molecules 52, and photopolymerization initiators 53 is injected between the first and the second orientation films AL1 and AL2. The monomers 51A and the liquid crystal molecules 52 are uniformly homogeneously oriented in a substantially horizontal direction between the first and the second orientation films AL1 and AL2 (the array substrate 10 and the counter substrate 20) by the rubbing treatment of the first and the second orientation films AL1 and AL2. When light is emitted for curing the seal after the solution LC′ is injected, masked exposure is preferably performed in order not to allow the light to be incident onto portions other than a sealing portion (not illustrated) for sealing the array substrate 10 and the counter substrate 20.

Then, in the state where the monomers 51A and the liquid crystal molecules 52 are homogeneously oriented, a bright line of a mercury lamp or a light-emitting diode (LED) light source is used to emit light having an absorption wavelength of the photopolymerization initiators 53 (for example, ultraviolet light UV such as i-line, g-line, or h-line). In this case, the ultraviolet light UV is preferably emitted from the array substrate 10 side, as illustrated in FIG. 7. As a result, a photocrosslinking reaction of the first orientation film AL1 proceeds further than that of the second orientation film AL2 does, so that the polymer network is more restrained from moving at the bathtub-shaped bottom of the pixel Pix.

In the present embodiment, a photocrosslinkable acrylate-based material represented by Chemical Formula 1 can be used as the monomers 51A. Each of the monomers represented by Chemical Formula 1 has acrylate groups having functions as photocrosslinkable groups at the right and left ends.

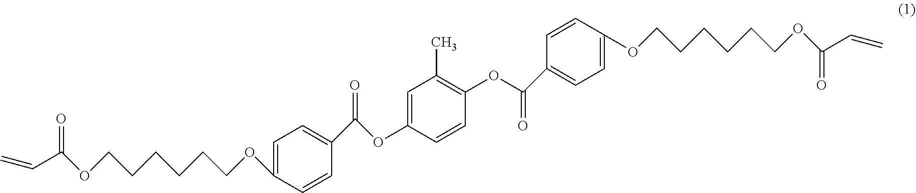 [SMILES: C=CC(=O)OCCCCCCOc1ccc(C(=O)Oc2ccc(OC(=O)c3ccc(OCCCCCCOC(=O)C=C)cc3)c(C)c2)cc1]

The ultraviolet irradiation described above causes the photopolymerization initiators 53 in the solution LC′ to absorb light and generate radicals. As a result, the monomers 51A in the solution LC′ perform a cross-linking reaction and are polymerized. The monomers 51A are not limited to those represented by Chemical Formula 1 above, and can be made using each of photocrosslinkable materials such as acrylate groups represented by Chemical Formulas 2-1 to 2-4 or maleimide groups represented by Chemical Formulas 2-5 to 2-8.

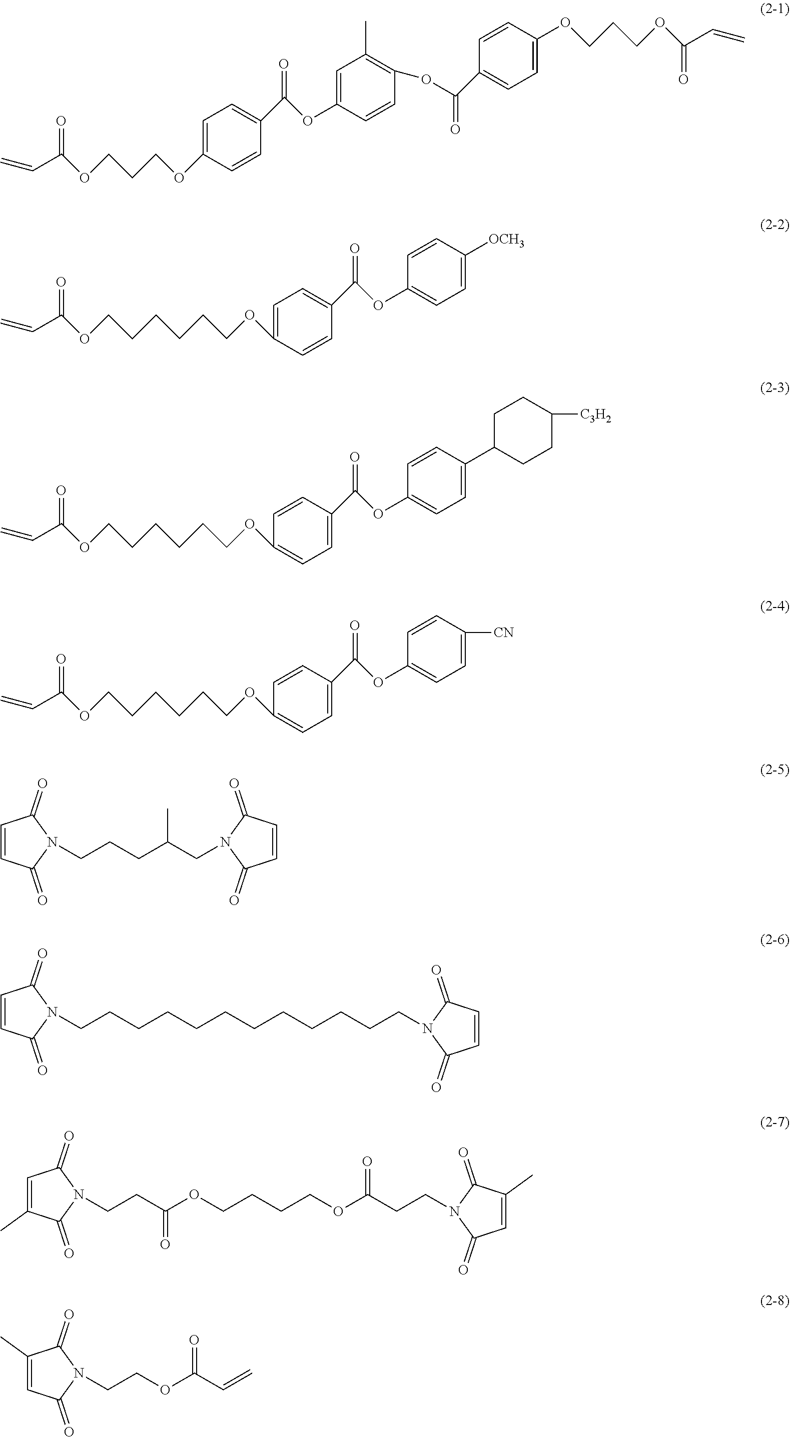

The liquid crystal molecules 52 are made using a nematic liquid crystal material having positive dielectric constant anisotropy Δε. When a liquid crystal material having positive dielectric constant anisotropy Δε is used, a liquid crystal composition (liquid crystal molecules 52) having large refractive index anisotropy Δn is preferably used, and the photocrosslinkable monomers 51A and the photopolymerization initiators 53 are included in addition to the liquid crystal molecules 52.

The ultraviolet irradiation at a predetermined wavelength causes the photopolymerization initiators 53 to generate radicals to initiate the polymerization of the monomers 51A. As the photopolymerization initiators 53, a material suitable for the ultraviolet wavelength to be used can be used. For example, one of the following can be used.

(±)-camphorquinone, acetophenone, benzophenone, 4-benzoylbenzoic acid, 2-benzoylbenzoic acid, methyl 2-benzoylbenzoate, 4,4′-bis(dimethylamino)benzophenone, 4,4′-bis(diethylamino)benzophenone, 4,4′-dichlorobenzophenone, 1,4-dibenzoylbenzene, benzil, p-anisyl, 2-benzoyl-2-propanol, 2-hydroxy-4′-(2-hydroxyethoxy)-2-methylpropiophenone, 1-benzylcyclohexanol, benzoin, benzoin methyl ether, benzoin ethyl ether, benzoin isopropyl ether, benzoin butyl ether, o-tosyl benzoin, 2,2-diethoxyacetophenone, benzyl dimethyl ketal, 2-methyl-4′-(methylthio)-2-morpholinopropiophenone, 2-benzyl-2-(dimethylamino)-4′-monoholinobutyrophenone, 2-isonitrosopropiophenone, 2-chlorothioxanthone, 2-isopropylthioxanthone, 2,4-diethylthioxanthen-9-one, 2,2′-bis(2-chlorophenyl)-4,4,5,5′-tetraphenyl-1,2′-biimidazole, diphenyl(2,4,6-trimethylbenzoyl)phosphine oxide, phenylbis(2,4,6-trimethylbenzoyl)phosphine oxide, and lithium phenyl (2,4,6-trimethylbenzoyl) phosphinate.

The photocrosslinking (polymerizing) reaction of the monomers 51A described above forms a three-dimensional mesh-shaped polymer network 51, as illustrated in FIG. 7. This process forms the liquid crystal layer 50 including the reverse-mode polymer-dispersed liquid crystals in which the liquid crystal molecules 52 are dispersed in gaps of the polymer network 51.

Normally, when the polymer network is formed by polymerizing the monomers, the polymer network is not fixed and floats in the liquid crystal layer. Therefore, for example, when factors such as point presses and drop impacts on a screen of the display panel cause an irreversible movement of the polymer network of the liquid crystal layer, there is possibility that the orientation of the liquid crystal molecules is disturbed. This phenomenon causes pixel-by-pixel unevenness and reduction in contrast of the display panel, and thus, improvement is required in impact resistance of the display device (display panel).

In the present embodiment, ends (portions) of the polymer network 51 are coupled to the first and the second orientation films AL1 and AL2. As a result, the polymer network 51 is fixed to the array substrate 10 and the counter substrate 20 with the first and the second orientation films AL1 and AL2 interposed therebetween. This configuration improves the impact resistance and reliability of the display panel 2 including the liquid crystal layer 50. An end (portion) of the polymer network 51 may be coupled to only the first orientation film AL1.

The following describes the first and the second orientation films AL1 and AL2. In the present embodiment, the first and the second orientation films AL1 and AL2 are preferably orientation films that are transparent in the visible range and are formed of polyimide. The polyimide can be obtained by heating and imidizing a polyamide acid (including a polyamide acid compound). For this purpose, a liquid polyamide acid is applied to surfaces of the pixel electrode PE and the common electrode CE by, for example, spin coating, and is imidized to form the first and the second orientation films AL1 and AL2. The polyamide acid can be synthesized by reacting a tetracarboxylic acid compound (tetracarboxylic dianhydride) with a diamine compound. As a result, as represented by Chemical Formula 3, the polyimide is formed to have a skeleton derived from tetracarboxylic dianhydride and a skeleton derived from a diamine compound.

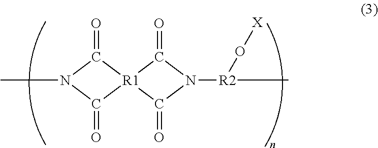

In Chemical Formula 3, R1 contained in the skeleton derived from tetracarboxylic dianhydride can be, for example, a cyclobutane skeleton, an alicyclic skeleton other than a cyclobutane skeleton, or a chain skeleton. R2 contained in the skeleton derived from a diamine compound can be, for example, an alicyclic skeleton other than a cyclobutane skeleton, or a chain skeleton. Examples of an alicyclic skeleton other than a cyclobutane skeleton include a cycloheptane skeleton and a cyclohexane skeleton. As an alicyclic skeleton, aromatic compounds can be used. However, those with less coloration of the polyimide are preferred.

In the present embodiment, the polyimide serving as the material (orientation film material) of the first and the second orientation films AL1 and AL2 has a photocrosslinkable group X on a side chain of the polyimide. Specifically, the photocrosslinkable group X is provided via an ether bond to the above-mentioned R2 that forms the skeleton derived from the diamine compound. The photocrosslinking group X may be provided via an ester bond instead of an ether bond. That is, the diamine compound forming the polyimide has the photocrosslinkable group X. The photocrosslinkable group X reacts with the monomers 51A during the above-described photocrosslinking (polymerizing) reaction of the monomers 51A, and connects each of the first and the second orientation films AL1 and AL2 to the polymer network 51 (polymer fibers). This process tightly connects the first and the second orientation films AL1 and AL2 to the polymer network 51, thereby improving the impact resistance and reliability of the display panel 2 including the liquid crystal layer 50.

The photocrosslinkable group X can be provided with, for example, an acrylate group as represented by Chemical Formula 4. In this case, R illustrated in Chemical Formula 4 means a group coupled to the photocrosslinkable group and includes the ether bond or the ester bond mentioned above.

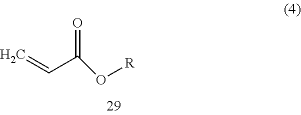

In this configuration, the photocrosslinkable group X is provided via the ether bond or the ester bond to the R2 contained in the skeleton derived from the diamine compound. As a result, the first and the second orientation films AL1 and AL2 formed of the polyimide containing the photocrosslinkable group X can be easily formed, and the first and the second orientation films AL1 and AL2 can be easily coupled to the polymer network 51. Since the photocrosslinkable group X is provided on the side chain of the polyimide, the degree of freedom of orientation is higher than when the photocrosslinkable group X is provided on a polymer main chain, and the efficiency of the photocrosslinking (polymerizing) reaction between the photocrosslinkable group X and the photocrosslinkable monomers 51A can be increased during the formation of the polymer network 51.

The photocrosslinkable group X is not limited to the acrylate group. At least one of a methacrylate group, a cinnamic acid group, a maleimide group, a phenyldiazirine, and a phenylazide represented by Chemical Formulae 5-1 to 5-5 may be provided on the side chain of the polyimide. Any one of these photocrosslinkable groups X may be provided on the main chain of the polyimide, or on the side chain or at an end of the main chain.

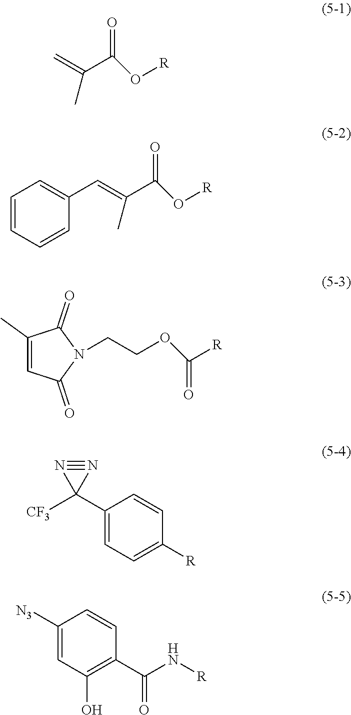

The following describes the polyimide having other configurations. Although the foregoing has described the configuration of the polyimide having the photocrosslinkable group X on the side chain, a configuration can also be employed in which the polyimide has the photocrosslinkable group on the main chain. Specifically, the polyimide having a diazo group represented by Chemical Formula 6-1 or the polyimide having a benzophenone group represented by Chemical Formula 6-2 can be employed as the photocrosslinkable group for the R1 contained in the skeleton derived from tetracarboxylic dianhydride in Chemical Formula 3. In Chemical Formulae 6-1 and 6-2, Et denotes an ethyl group. Structural formulae illustrated in Chemical Formulae 6-1 and 6-2 are examples, and other configurations may be used as long as the polyimide has a diazo group or a benzophenone group.

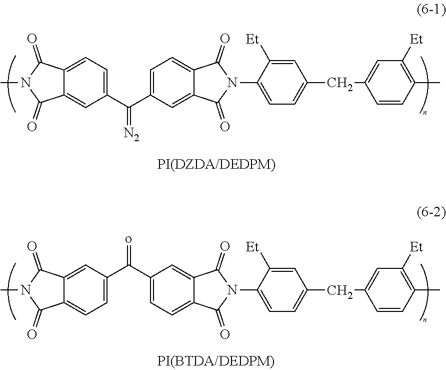

In this configuration, since the polyimide originally has a functional group that serves as a photocrosslinkable group, the first and the second orientation films AL1 and AL2 can be easily coupled to the polymer network 51. The photocrosslinkable group is provided on the main chain of the polyimide. Therefore, after the first and the second orientation films AL1 and AL2 are coupled to the polymer network 51, the polymer network 51 is difficult to move and thus can be fixed.

In the above-described configuration, both the polymer network 51 and the liquid crystal molecules 52 are optically anisotropic. The orientation of the liquid crystal molecules 52 is controlled by a voltage difference between the pixel electrode PE and the common electrode CE. The orientation of the liquid crystal molecules 52 is changed by the voltage applied to the pixel electrode PE. The degree of scattering of light passing through the pixel Pix (area on the pixel electrode PE) changes with the change in the orientation of the liquid crystal molecules 52.

For example, as illustrated in FIG. 7, the direction of an optical axis AX1 of the polymer network 51 is substantially equal to the direction of an optical axis AX2 of the liquid crystal molecules 52 when no voltage is applied between the pixel electrode PE and the common electrode CE. The optical axis Ax2 of the liquid crystal molecules 52 is parallel to the direction PY of the liquid crystal layer 50 (FIG. 5). The optical axis AX1 of the polymer network 51 is parallel to the direction PY of the liquid crystal layer 50 regardless of whether the voltage is applied.

The polymer network 51 and the liquid crystal molecules 52 have the same ordinary-ray refractive index. When no voltage is applied between the pixel electrode PE and the common electrode CE, the difference of refractive index between the polymer network 51 and the liquid crystal molecules 52 is substantially zero in all directions. The liquid crystal layer 50 is placed in the non-scattering state of not scattering the light-source light L (FIG. 5). As illustrated in FIG. 5, the light-source light L propagates in a direction away from the light source 3 (light emitter 31) while being reflected by the first principal surface 10A of the array substrate 10 and the first principal surface 20A of the counter substrate 20. When the liquid crystal layer 50 is in the non-scattering state of not scattering the light-source light L, a background on the first principal surface 20A side of the counter substrate 20 is visible from the first principal surface 10A of the array substrate 10, and a background on the first principal surface 10A side of the array substrate 10 is visible from the first principal surface 20A of the counter substrate 20.

As illustrated in FIG. 9, in the gap between the pixel electrode PE and the common electrode CE having a voltage applied thereto, the optical axis AX2 of the liquid crystal molecules 52 is inclined by an electric field generated between the pixel electrode PE and the common electrode CE. Since the optical axis AX1 of the polymer network 51 is not changed by the electric field, the direction of the optical axis AX1 of the polymer network 51 differs from the direction of the optical axis AX2 of the liquid crystal molecules 52. The light-source light L is scattered in the pixel Pix including the pixel electrode PE having a voltage applied thereto. As described above, the viewer views a portion of the scattered light-source light L emitted outward from the first principal surface 10A of the array substrate 10 or the first principal surface 20A of the counter substrate 20.

In the pixel Pix including the pixel electrode PE having no voltage applied thereto, the background on the first principal surface 20A side of the counter substrate 20 is visible from the first principal surface 10A of the array substrate 10, and the background on the first principal surface 10A side of the array substrate 10 is visible from the first principal surface 20A of the counter substrate 20. In the display device 1 of the present embodiment, when the first input signal VS is received from the image transmitter 91, the voltage is applied to the pixel electrode PE of the pixel Pix for displaying an image, and an image based on the third input signal VCSA becomes visible together with the background. In this manner, the image is displayed in the display area when the polymer-dispersed liquid crystal LC is in a scattering state.

The light-source light L is scattered in the pixel Pix including the pixel electrode PE having a voltage applied thereto, and emitted outward to display the image, which is displayed so as to be superimposed on the background. In other words, the display device 1 of the present embodiment can display the image so as to be superimposed on the background by combining the emission light 68 or the emission light 68A with the background.

A potential of each of the pixel electrodes PE (refer to FIG. 7) written during the one vertical scan period GateScan illustrated in FIG. 3 needs to be held during at least one of the first color light emission period RON, the second color light emission period GON, and the third color light emission period BON coming after the one vertical scan period GateScan. If the written potential of each of the pixel electrodes PE (refer to FIG. 7) cannot be held during at least one of the first color light emission period RON, the second color light emission period GON, and the third color light emission period BON coming after the one vertical scan period GateScan, what are called flickers, for example, are likely to occur. In other words, in order to shorten the one vertical scan period GateScan serving as a time for selecting the scan lines and increase the visibility in the driving based on what is called the field-sequential system, the written potential of each of the pixel electrodes PE (refer to FIG. 7) is required to be easily held during each of the first color light emission period RON, the second color light emission period GON, and the third color light emission period BON.

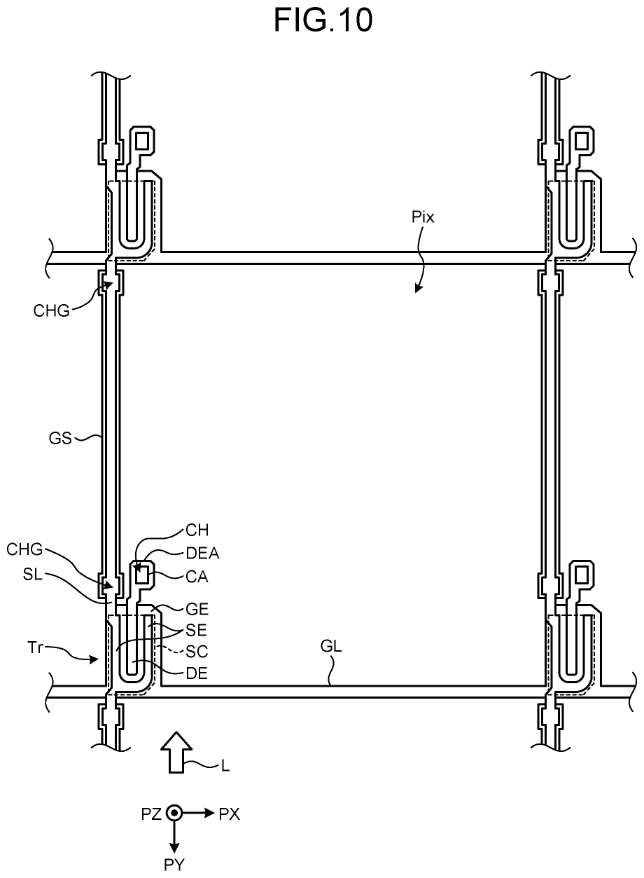

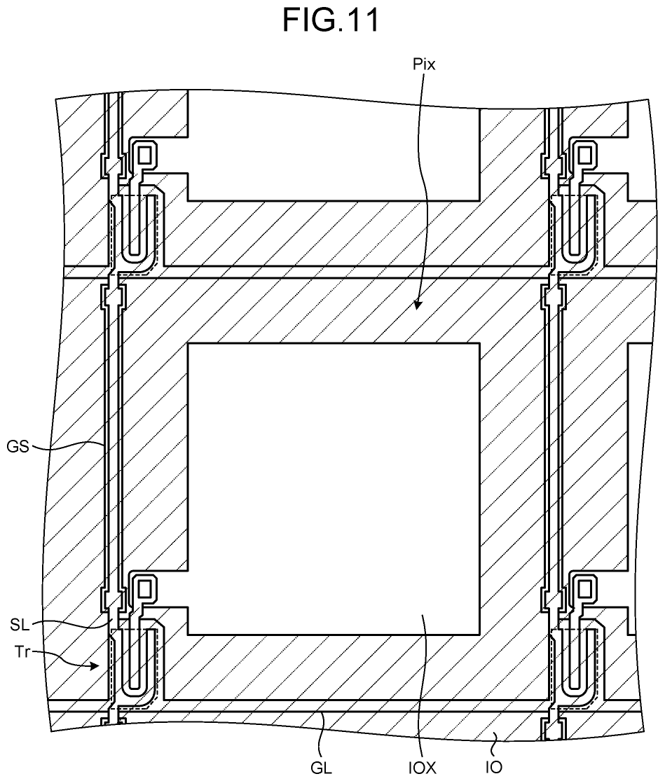

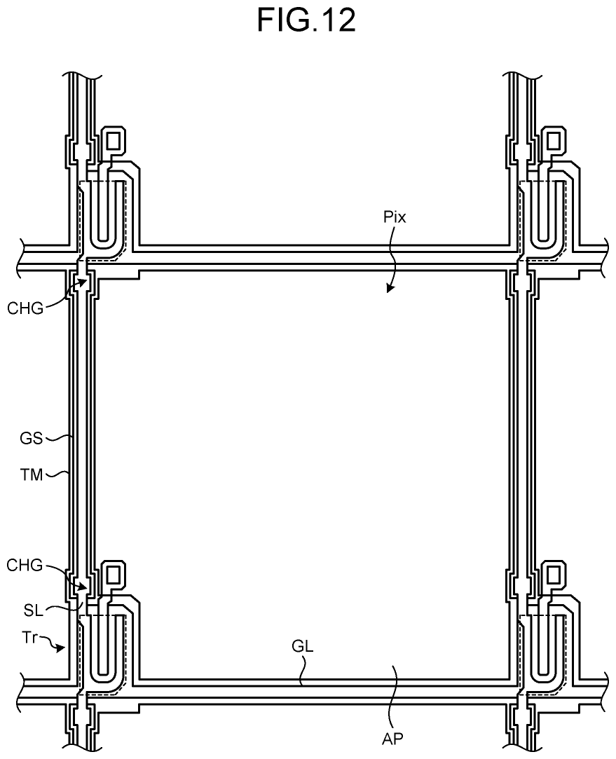

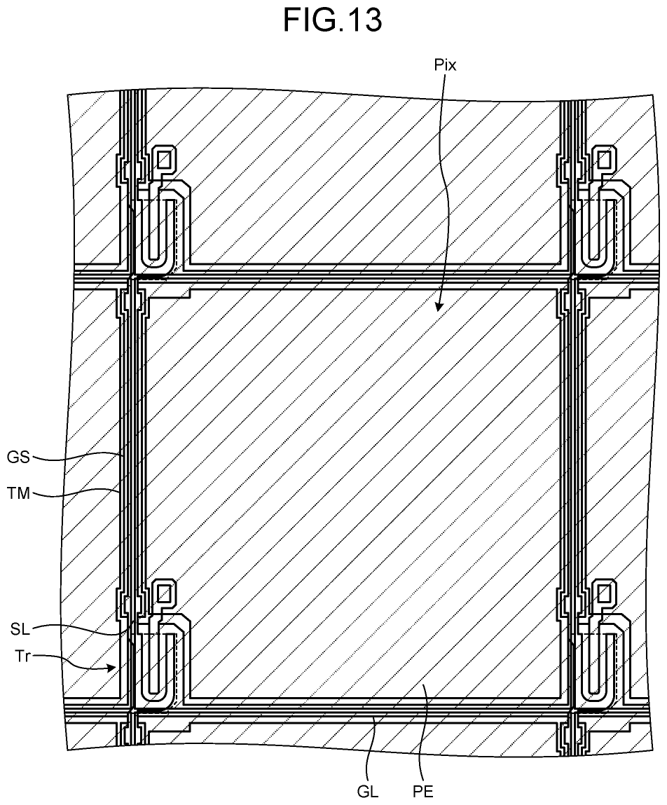

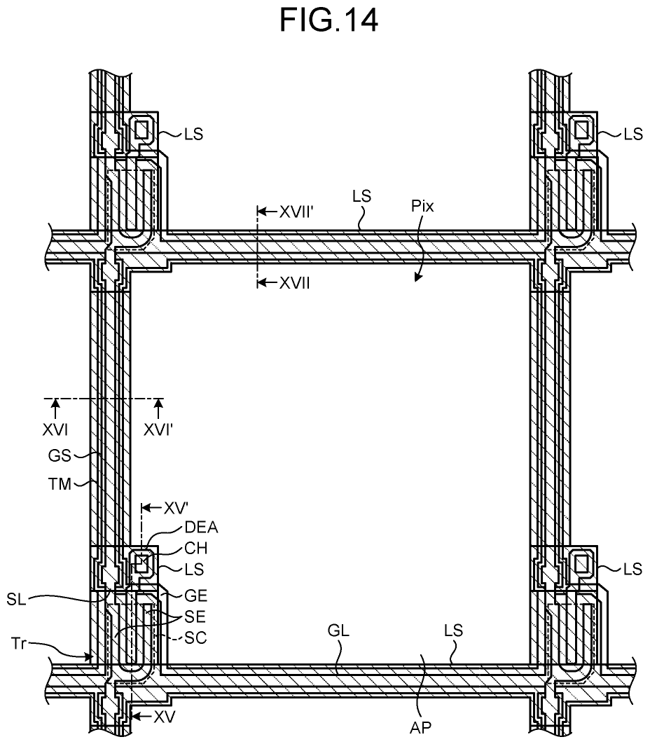

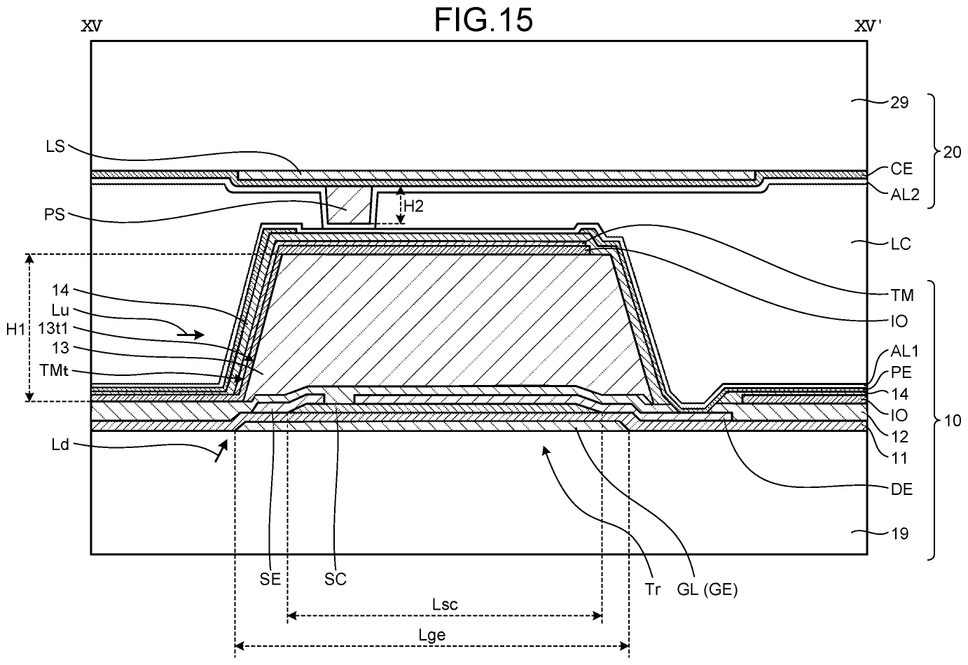

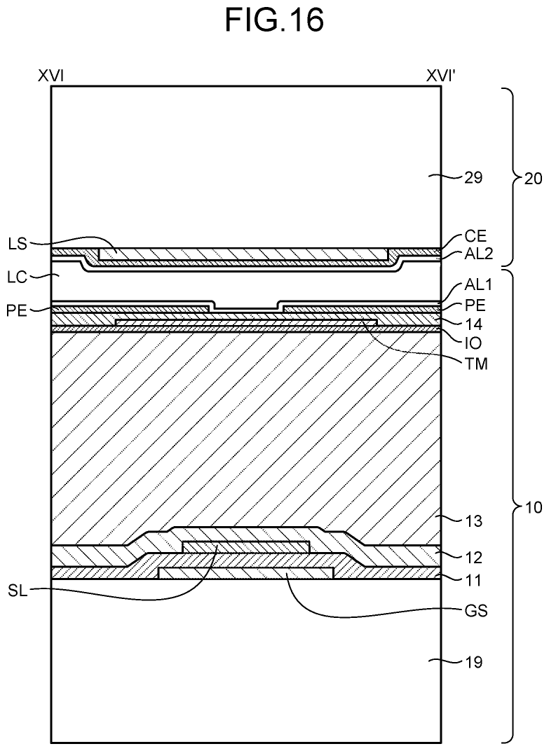

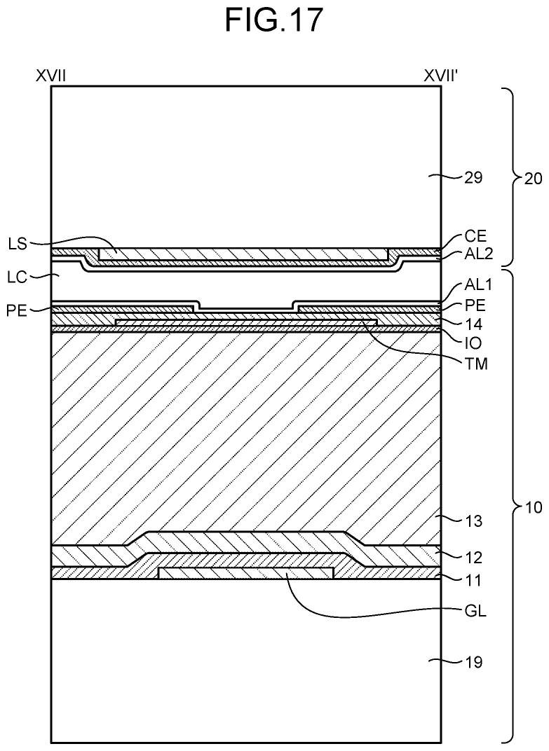

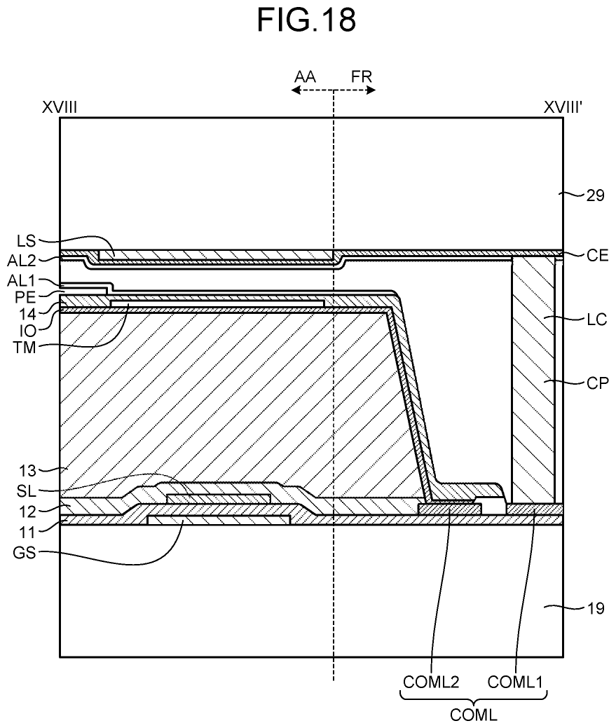

FIG. 10 is a plan view illustrating the scan lines, the signal lines, and the switching element in the pixel. FIG. 11 is a plan view illustrating a holding capacitance layer in the pixel. FIG. 12 is a plan view illustrating an auxiliary metal layer and an opening area in the pixel. FIG. 13 is a plan view illustrating the pixel electrode in the pixel. FIG. 14 is a plan view illustrating a light-blocking layer in the pixel. FIG. 15 is a sectional view along XV-XV′ of FIG. 14. FIG. 16 is a sectional view along XVI-XVI′ of FIG. 14. FIG. 17 is a sectional view along XVII-XVII′ of FIG. 14. FIG. 18 is a sectional view of the peripheral area. As illustrated in FIGS. 1, 2, and 10, the array substrate 10 is provided with the signal lines SL and the scan lines GL so as to form a grid in plan view. In other words, one surface of the array substrate 10 is provided with the signal lines arranged in the first direction PX with spaces therebetween and the scan lines arranged in the second direction PY with spaces therebetween.

As illustrated in FIG. 10, an area surrounded by the adjacent scan lines GL and the adjacent signal lines SL corresponds to the pixel Pix. The pixel Pix is provided with the pixel electrode PE and the switching element Tr. In the present embodiment, the switching element Tr is a bottom-gate thin film transistor. The switching element Tr includes a semiconductor layer SC overlapping, in plan view, a gate electrode GE electrically coupled to a corresponding one of the scan lines GL.

As illustrated in FIG. 10, the scan lines GL are wiring of a metal such as molybdenum (Mo) or aluminum (Al), a multilayered body of these metals, or an alloy thereof. The signal lines SL are wiring of a metal such as aluminum or an alloy thereof.

As illustrated in FIG. 10, the semiconductor layer SC is provided so as not to protrude from the gate electrode GE in plan view. As a result, the light-source light L traveling toward the semiconductor layer SC from the gate electrode GE side is reflected, and light leakage is less likely to occur in the semiconductor layer SC.

As illustrated in FIGS. 5 and 10, the light-source light L emitted from the light source 3 is incident in the second direction PY serving as a direction of incidence. When the direction of incidence of the light-source light L is the second direction PY, the width in the first direction of the semiconductor layer SC is less than the width in the second direction of the semiconductor layer SC. This configuration reduces the width in a direction intersecting the direction of incidence of the light-source light L, and thereby, reduces the effect of light leakage.

As illustrated in FIG. 10, two electrical conductors of a source electrode SE that are the same as the signal line SL extend from the signal line SL in the same layer as that of the signal line SL and in a direction intersecting the signal line. With this configuration, the source electrode SE electrically coupled to the signal line SL overlaps one end of the semiconductor layer SC in plan view.

As illustrated in FIG. 10, in plan view, a drain electrode DE is provided in a position between the adjacent electrical conductors of the source electrode SE. The drain electrode DE overlaps the semiconductor layer SC in plan view. A portion of the semiconductor layer SC overlapping neither the source electrode SE nor the drain electrode DE serves as a channel of the switching element Tr. As illustrated in FIG. 13, a contact electrode DEA electrically coupled to the drain electrode DE is electrically coupled to the pixel electrode PE through a contact hole CH.

As illustrated in FIG. 15, the array substrate 10 includes the first light-transmitting base member 19 formed of, for example, glass. The first light-transmitting base member 19 may be made of a resin such as polyethylene terephthalate, as long as having a light transmitting capability.

As illustrated in FIG. 15, the scan line GL (refer to FIG. 10) and the gate electrode GE are provided on the first light-transmitting base member 19.

In addition, as illustrated in FIG. 15, a first insulating layer 11 is provided so as to cover the scan line GL and the gate electrode GE. The first insulating layer 11 is formed of, for example, a transparent inorganic insulating material such as silicon nitride.

The semiconductor layer SC is stacked on the first insulating layer 11. The semiconductor layer SC is formed of, for example, amorphous silicon, but may be formed of polysilicon or an oxide semiconductor. When viewed in the same section, a width Lsc of the semiconductor layer SC is less than a width Lge of the gate electrode GE overlapping the semiconductor layer SC. With this configuration, the gate electrode GE can block light Ld that has propagated in the first light-transmitting base member 19. As a result, light leakage of the switching element Tr of the first embodiment is reduced.

The source electrode SE and the signal line SL covering a portion of the semiconductor layer SC and the drain electrode DE covering a portion of the semiconductor layer SC are provided on the first insulating layer 11. The drain electrode DE is formed of the same material as that of the signal line SL. A second insulating layer 12 is provided on the semiconductor layer SC, the signal line SL, and the drain electrode DE. The second insulating layer 12 is formed of, for example, a transparent inorganic insulating material such as silicon nitride, in the same manner as the first insulating layer 11.

A third insulating layer covering a portion of the second insulating layer 12 is formed on the second insulating layer 12. A third insulating layer 13 is formed of, for example, a light-transmitting organic insulating material such as an acrylic resin. The third insulating layer 13 has a film thickness greater than other insulating films formed of an inorganic material.

As illustrated in FIGS. 15, 16, and 17, some areas have the third insulating layer 13 while the other areas do not have the third insulating layer 13. As illustrated in FIGS. 16 and 17, the areas having the third insulating layer 13 are located over the scan lines GL and over the signal lines SL. The third insulating layer 13 has a grid shape along the scan lines GL and the signal lines SL and covers over the scan lines GL and the signal lines SL. As illustrated in FIG. 15, the areas having the third insulating layer 13 are also located over the semiconductor layer SC, that is, over the switching elements Tr. As a result, the switching element Tr, the scan line GL, and the signal line SL are located at relatively long distances from the holding capacitance electrode IO, and are thereby less affected by a common potential from the holding capacitance electrode IO. In addition, areas on the array substrate 10 not having the third insulating layer 13 are provided in the areas surrounded by the scan lines GL and the signal lines SL. Thus, areas are provided in which the thickness of the insulating layer is less than the thickness of the insulating layer overlapping the signal lines SL and the scan lines GL in plan view. The areas surrounded by the scan lines GL and the signal lines SL have relatively higher optical transmittance than the areas over the scan lines GL and over the signal lines SL, and thus, are improved in light transmitting capability.

As illustrated in FIG. 15, the holding capacitance electrode IO is provided on the third insulating layer 13. The holding capacitance electrode IO is formed of a light-transmitting conductive material such as indium tin oxide (ITO). The holding capacitance electrode IO is also called “third light-transmitting electrode”. As illustrated in FIG. 11, the holding capacitance electrode IO has an area IOX including no light-transmitting conductive material in each of the areas surrounded by the scan lines GL and the signal lines SL. The holding capacitance electrode IO extends across the adjacent pixels Pix and is provided over the pixels Pix. An area of the holding capacitance electrode IO including the light-transmitting conductive material overlaps the scan line GL or the signal line SL and extends to the adjacent pixel Pix.

The holding capacitance electrode IO has a grid shape that covers over the scan lines GL and the signal lines SL along the scan lines GL and the signal lines SL. With this configuration, the holding capacitance HC between the area IOX including no light-transmitting conductive material and the pixel electrode PE is reduced. Therefore, the holding capacitance HC is adjusted by the size of the area IOX including no light-transmitting conductive material.

As illustrated in FIG. 15, a conductive metal layer TM is provided on a portion of the holding capacitance electrode IO. The conductive metal layer TM is wiring of a metal such as molybdenum (Mo) or aluminum (Al), a multilayered body of these metals, or an alloy thereof. As illustrated in FIG. 12, the metal layer TM is provided in regions overlapping the signal lines SL, the scan lines GL, and the switching element Tr in plan view. With this configuration, the metal layer TM is formed into a grid shape, and an opening AP surrounded by the metal layer TM is formed.

As illustrated in FIG. 12, the switching element Tr coupled to the scan line GL and the signal line SL is provided. At least the switching element Tr is covered with the third insulating layer 13 serving as an organic insulating layer, and the metal layer TM having a larger area than that of the switching element Tr is located above the third insulating layer 13. This configuration can reduce the light leakage of the switching element Tr.

The metal layer TM may be located below the holding capacitance electrode IO, and only needs to be stacked with the holding capacitance electrode IO. The metal layer TM has a lower electrical resistance than that of the holding capacitance electrode IO. Therefore, the potential of the holding capacitance electrode IO is restrained from varying with the position where the pixel Pix is located in the display area AA.

As illustrated in FIG. 12, the width of the metal layer TM overlapping the signal line SL is greater than the width of the signal line SL in plan view. This configuration restrains reflected light reflected by edges of the signal line SL from being emitted from the display panel 2. The width of the metal layer TM and the width of the signal line SL are lengths in a direction intersecting the extending direction of the signal line SL. The width of the metal layer TM overlapping the scan line GL is greater than the width of the scan line GL. The width of the metal layer TM and the width of the scan line GL are lengths in a direction intersecting the extending direction of the scan line GL.

As illustrated in FIG. 15, a fourth insulating layer 14 is provided on the upper side of the holding capacitance electrode IO and the metal layer TM. The fourth insulating layer 14 is an inorganic insulating layer formed of, for example, a transparent inorganic insulating material such as silicon nitride.

As illustrated in FIG. 15, the pixel electrode PE is provided on the fourth insulating layer 14. The pixel electrode PE is formed of a light-transmitting conductive material such as ITO. The pixel electrode PE is electrically coupled to the contact electrode DEA through the contact hole CH provided in the fourth insulating layer 14, the third insulating layer 13, and the second insulating layer 12. As illustrated in FIG. 13, the pixel electrodes PE are partitioned into each of the pixels Pix. The first orientation film AL1 is provided on the upper side of the pixel electrode PE.

As illustrated in FIG. 15, the counter substrate 20 includes the second light-transmitting base member 29 formed of, for example, glass. The second light-transmitting base member 29 may be made of a resin such as polyethylene terephthalate, as long as having a light transmitting capability. The second light-transmitting base member 29 is provided with the common electrode CE. The common electrode CE is formed of a light-transmitting conductive material such as ITO. The second orientation film AL2 is provided on a surface of the common electrode CE. The counter substrate 20 includes a light-blocking layer LS between the second light-transmitting base member 29 and the common electrode CE. The light-blocking layer LS is formed of a resin or a metal material colored in black. A spacer PS is formed between the array substrate 10 and the counter substrate 20. The spacer PS is located between the common electrode CE and the second orientation film AL2. The spacer PS regulates the distance between the array substrate 10 and the counter substrate 20.

As illustrated in FIGS. 12 and 16, in the display device of the first embodiment, a light-blocking layer GS located in the same layer as that of the scan line GL is provided in a position extending along the signal line SL and overlapping a portion of the signal line SL. The light-blocking layer GS is formed of the same material as that of the scan line GL. The light-blocking layer GS is not provided at a portion where the scan line GL intersects the signal line SL in plan view.

As illustrated in FIG. 12, the light-blocking layer GS is electrically coupled to the signal line SL through a contact hole CHG. With this configuration, the wiring resistance obtained by combining the light-blocking layer GS with the signal line SL is lower than that of only the signal line SL. As a result, the delay of the gradation signal supplied to the signal line SL is reduced. The contact hole CHG may not be provided, and the light-blocking layer GS may not be coupled to the signal line SL.

As illustrated in FIG. 16, the light-blocking layer GS is provided opposite to the metal layer TM with the signal line SL therebetween. The width of the light-blocking layer GS is greater than that of the signal line SL and less than that of the metal layer TM. The width of the light-blocking layer GS, the width of the metal layer TM, and the width of the signal line SL are lengths in a direction intersecting the extending direction of the signal line SL. In this manner, the light-blocking layer GS has a width greater than that of the signal line SL, and thus, restrains the reflected light reflected by the edges of the signal line SL from being emitted from the display panel 2. As a result, the visibility of images is improved in the display device 1.

As illustrated in FIGS. 14 and 15, the counter substrate 20 is provided with the light-blocking layer LS. The light-blocking layer LS is provided in an area overlapping the signal line SL, the scan line GL, and the switching element Tr in plan view.

As illustrated in FIGS. 14, 15, 16, and 17, the light-blocking layer LS has a width greater than that of the metal layer TM. This configuration restrains reflected light reflected by edges of the signal line SL, the scan line GL, and the metal layer TM from being emitted from the display panel 2. As a result, the visibility of images is improved in the display device 1.

The contact hole CH and the contact hole CHG are likely to diffusely reflect the light-source light L emitted thereto. Therefore, the light-blocking layer LS is provided in an area overlapping the contact holes CH and CHG in plan view.

As illustrated in FIG. 15, the spacer PS is disposed between the array substrate 10 and the counter substrate 20 and improves the uniformity of the distance between the array substrate 10 and the counter substrate 20.

As illustrated in FIG. 18, the common potential wiring COML is drawn in the peripheral area FR. The common potential wiring COML includes, for example, first common potential wiring COML1 and second common potential wiring COML2. The first common potential wiring COML1 is electrically coupled to the common electrode CE of the counter substrate 20 through a conductive member CP having electrical conductivity. The conducting pillar CP may be a conductive pillar (pillar), or may be a sealing material containing conductive particles such as Au particles.

As illustrated in FIG. 18, in the peripheral area FR, the holding capacitance electrode IO is electrically coupled to the second common potential wiring COML2. The metal layer TM is located in the display area AA.

As described above, the display device 1 includes the array substrate 10, the counter substrate 20, the liquid crystal layer 50, and the light source 3. The array substrate 10 includes the pixel electrodes PE serving as first light-transmitting electrodes each disposed in a corresponding one of the pixels Pix. The array substrate 10 is provided with the signal lines SL arranged in the first direction PX with spaces therebetween and the scan lines GL arranged in the second direction PY with spaces therebetween. The counter substrate 20 includes the common electrode CE serving as a second light-transmitting electrode in a position overlapping the pixel electrodes PE in plan view. The liquid crystal layer 50 includes the polymer-dispersed liquid crystals LC filled between the array substrate 10 and the counter substrate 20. The light emitters 31 of the light source 3 emit the light in the second direction PY to a side surface of the counter substrate 20. The direction of incidence of the light that propagates in the array substrate 10 and the counter substrate 20 is the second direction. The light emitters 31 may emit the light that propagates in the array substrate 10 and the counter substrate 20 toward a side surface of the array substrate 10.

The array substrate 10 includes the third insulating layer 13 and the metal layer TM. The third insulating layer 13 serves as an organic insulating layer that covers at least the switching element Tr. The metal layer TM is provided above the third insulating layer 13 so as to overlap therewith and has a larger area than that of the switching element Tr. The area surrounded by the scan lines GL and the signal lines SL has a second area having a thickness less than that of the third insulating layer 13 in a first area that overlaps the switching element Tr, the scan lines GL, and the signal lines SL in plan view. As illustrated in FIG. 15, a thickness H2 of the spacer PS is less than a thickness H1 of the third insulating layer 13 in the first area.

This configuration reduces the gap between the counter substrate 20 and the third insulating layer 13 in the first area overlapping the switching element Tr, the scan line GL, and the signal line SL. Therefore, irreversible movement of the polymer network of the liquid crystals LC through the gap, which would be caused by factors such as the point presses and the drop impacts on the screen of the display panel, hardly occurs. As a result, the alignment characteristics of the liquid crystal molecules become more uniform between the pixels Pix, and the degree of transmittance becomes substantially the same between pixels, thus making it difficult for the display quality to deteriorate.

The array substrate 10 includes the first orientation film AL1 in contact with the liquid crystals LC. The liquid crystals LC are polymer-dispersed liquid crystals that contain the polymer network formed in a mesh shape and the liquid crystal molecules held in a dispersed manner in the gaps of the polymer network. The first orientation film AL1 contains the photocrosslinkable group coupled to the polymer network. This configuration more restrains the movement of the polymer network at the bathtub-shaped bottom of the pixel Pix. As a result, the alignment characteristics of the liquid crystal molecules become more uniform between the pixels Pix, and the degree of transmittance becomes substantially the same between pixels, thus making it difficult for the display quality to deteriorate.

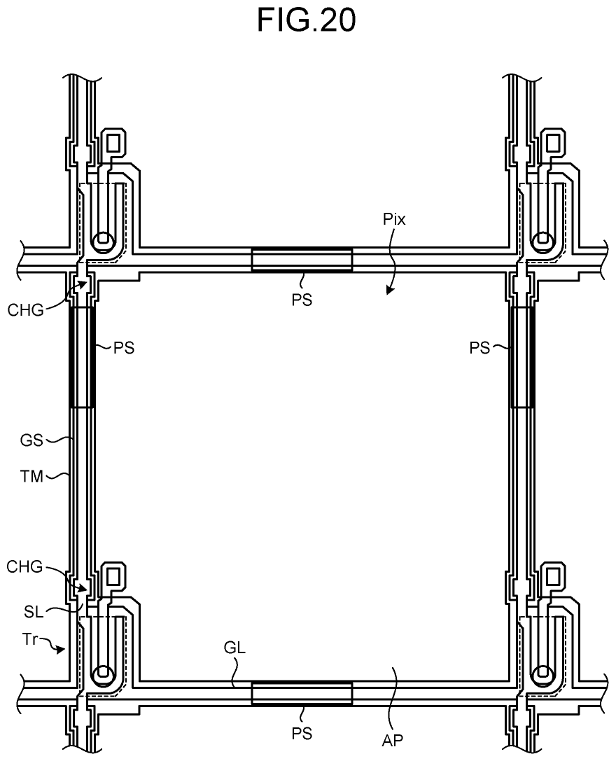

As illustrated in FIGS. 5 and 20, the light-source light L emitted from the light source 3 is incident in the second direction PY serving as a direction of incidence. Light Lu arrives as illustrated in FIG. 15. The light Lu is a part of the light-source light L that arrives from a side closer to the light source 3 than the switching element Tr is. The metal layer TMt blocks the light Lu, and thereby, reduces light leakage.

The metal layer TM may not be provided on slant surfaces along which the thickness of the third insulating layer 13 overlapping the switching element Tr changes, except for a first slant surface of the third insulating layer 13.

### Second Embodiment

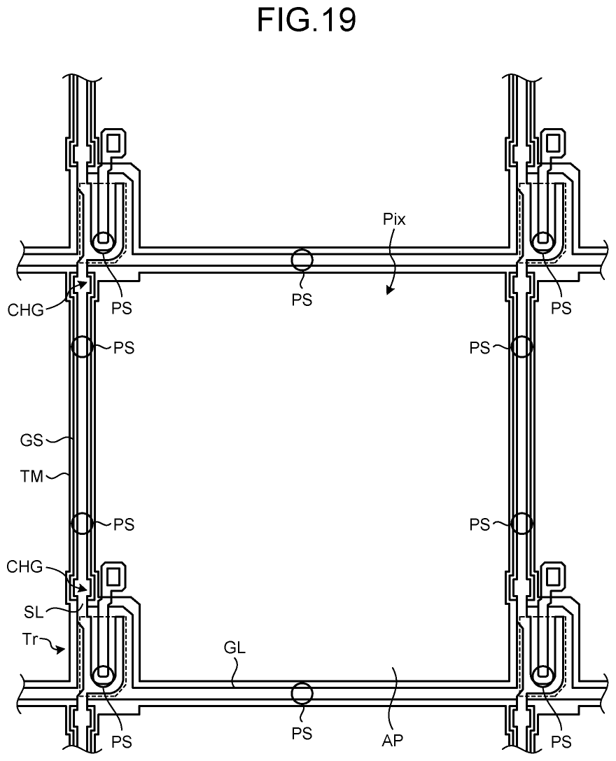

FIG. 19 is a plan view illustrating the shape and positions of the spacers in the display device according to a second embodiment of the present disclosure. The same components as those described in the first embodiment described above are denoted by the same reference numerals, and the description thereof will not be repeated.

As illustrated in FIG. 19, the spacers PS are arranged in positions overlapping the switching elements Tr, the signal lines SL, and the scan lines GL in plan view. The spacer PS has a circular sectional shape in plan view.

A plurality of the spacers PS are arranged so as to overlap one signal line SL in plan view, and adjacent two of the spacers PS are arranged with a space interposed therebetween. With this arrangement, the spacers PS themselves serve as obstacles and make it difficult for the polymer network of the liquid crystals LC to irreversibly move through the gap between the third insulating layer 13 in the first area overlapping the signal line SL and the counter substrate 20.

As illustrated in FIG. 19, the scan line GL for each of the pixels Pix is provided with the spacer PS that overlaps the scan line GL in plan view. Therefore, in the adjacent pixels Pix, a plurality of the spacers PS are arranged so as to overlap with one scan line GL in plan view, and the adjacent two of the spacers PS are arranged with a space interposed therebetween. With this arrangement, the spacers PS themselves serve as obstacles and make it difficult for the polymer network of the liquid crystals LC to irreversibly move through the gap between the third insulating layer 13 in the first area overlapping the scan line GL and the counter substrate 20.

As described above, since the adjacent two of the spacers PS are arranged with a space interposed therebetween, the liquid crystal LC layer can be filled during manufacturing.

### Third Embodiment

FIG. 20 is a plan view illustrating shapes and positions of the spacers in the display device according to a third embodiment of the present disclosure. The same components as those described in the first embodiment described above are denoted by the same reference numerals, and the description thereof will not be repeated.

As illustrated in FIG. 20, the spacers PS are arranged in positions overlapping the switching elements Tr, the signal lines SL, and the scan lines GL in plan view. The spacers PS overlapping the switching elements Tr in plan view have a circular sectional shape in plan view. The spacers PS overlapping the signal lines SL and the scan lines GL in plan view have a rectangular sectional shape in plan view.

As illustrated in FIG. 20, the signal line SL for each of the pixels Pix is provided with the spacer PS that overlaps the signal line SL in plan view. Therefore, in the adjacent pixels Pix, a plurality of the spacers PS are arranged SL so as to overlap with one signal line in plan view, and the adjacent two of the spacers PS are arranged with a space interposed therebetween. The longitudinal direction of the spacer PS is along the longitudinal direction of the signal line SL. With this arrangement, the spacers PS themselves are larger than those in the second embodiment and make it difficult for the polymer network of the liquid crystals LC to irreversibly move through the gap between the third insulating layer 13 in the first area overlapping the signal line SL and the counter substrate 20.

As illustrated in FIG. 20, the scan line GL for each of the pixels Pix is provided with the spacer PS that overlaps the scan line GL in plan view. Therefore, in the adjacent pixels Pix, a plurality of the spacers PS are arranged so as to overlap with one scan line GL in plan view, and the adjacent two of the spacers PS are arranged with a space interposed therebetween. The longitudinal direction of the spacer PS is along the longitudinal direction of the scan line GL. With this arrangement, the spacers PS themselves are larger than those in the second embodiment and make it difficult for the polymer network of the liquid crystals LC to irreversibly move through the gap between the third insulating layer 13 in the first area overlapping the scan line GL and the counter substrate 20.

As described above, since the adjacent two of the spacers PS are arranged with a space interposed therebetween, the liquid crystal LC layer can be filled during manufacturing.

### Fourth Embodiment

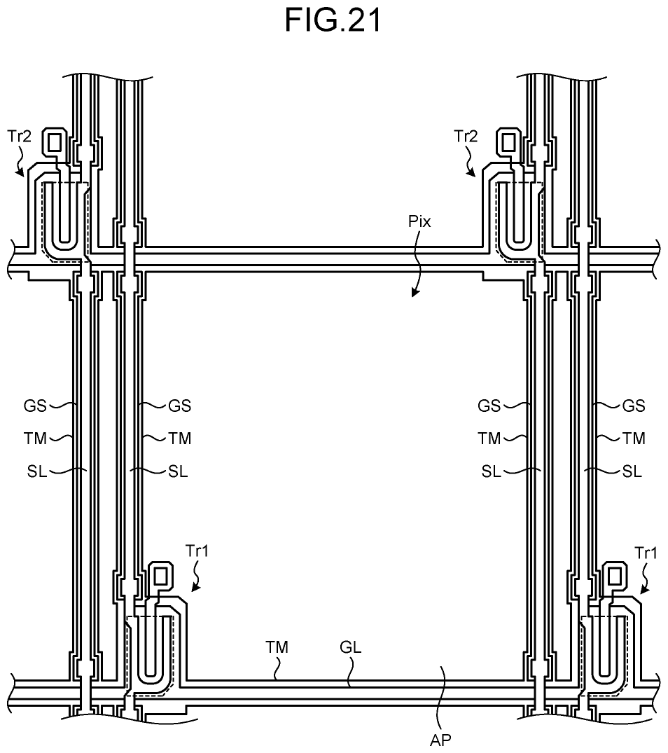

FIG. 21 is a plan view illustrating a pixel according to a fourth embodiment of the present disclosure. The same components as those described in any of the embodiments described above are denoted by the same reference numerals, and the description thereof will not be repeated.

As illustrated in FIG. 21, the configuration of the pixels Pix of the fourth embodiment differs from that of the pixels Pix of the first embodiment in that two signal lines SL are provided between adjacent pixels Pix. One of the signal lines SL is electrically coupled to switching elements Tr1 provided at intersections of the signal line SL and the scan lines GL for every other pixel Pix. The other of the signal lines SL is electrically coupled to switching elements Tr2 provided at intersections of the signal line SL and the scan lines GL for every other pixel Pix except the pixel Pix having the switching element Tr1.

This configuration allows the gate drive circuit 43 to simultaneously select adjacent two of the scan lines GL. As a result, the one vertical scan period GateScan illustrated in FIG. 3 is reduced. The reduction of the one vertical scan period GateScan relatively increases the first color light emission period RON, the second color light emission period GON, and the third color light emission period BON after the one vertical scan period GateScan.

### Modification

The first to the third embodiments have been described on the assumption that the switching element Tr has a bottom-gate structure. However, as described above, the switching element Tr is not limited to the bottom-gate structure and may have a top-gate structure. If the switching element Tr has the top-gate structure, referring to the multilayered insulating film structure of FIG. 15, the structure will be such that the semiconductor layer SC is disposed between the first light-transmitting base member 19 and the first insulating layer 11, the gate electrode GE is disposed between the first insulating layer 11 and the second insulating layer 12, and the source electrode SE and the contact electrode DEA are formed between the second insulating layer 12 and the third insulating layer 13.

In addition, a direct-current voltage may be supplied as the common potential. That is, the common potential may be constant. Alternatively, an alternating-current voltage may be shared as the common potential. That is, the common potential may have two values of an upper limit value and a lower limit value. Whether the common potential is a direct-current potential or an alternating-current potential, the common potential is supplied to the holding capacitance electrode 10 and the common electrode CE.

As the third insulating layer 13 serving as a grid-shaped organic insulating film, the structure is disclosed in which the third insulating layer 13 inside the grid-shaped area is entirely removed, and the second insulating layer 12 and the holding capacitance electrode 10 in the lower layers are exposed. However, the present disclosure is not limited to this structure. For example, the structure may be obtained by using a halftone exposure technique to leave a thin part of the third insulating layer 13 inside the grid-shaped area surrounded by the signal lines SL and the scan lines GL. With this structure, the thickness of the third insulating layer 13 inside the grid-shaped area is made smaller than the thickness of the grid-shaped area surrounded by the signal lines SL and the scan lines GL.

While the preferred embodiments have been described above, the present disclosure is not limited to such embodiments. The content disclosed in the embodiments is merely an example, and can be variously modified within the scope not departing from the gist of the present disclosure. Any modifications appropriately made within the scope not departing from the gist of the present disclosure also naturally belong to the technical scope of the present disclosure.

What is claimed is:

1. A display device comprising:
an array substrate;
a counter substrate;
a liquid crystal layer between the array substrate and the counter substrate;
spacers that regulate a distance between the array substrate and the counter substrate; and
a light source disposed so as to emit light into a side surface of the array substrate or a side surface of the counter substrate,
wherein the array substrate comprises:
signal lines arranged in a first direction with spaces interposed between the signal lines;
scan lines arranged in a second direction with spaces interposed between the scan lines;
switching elements each of which is coupled to a corresponding one of the scan lines and a corresponding one of the signal lines; and
an organic insulating layer that covers at least the switching elements,
wherein an area surrounded by the scan lines and the signal lines has a second area having a thickness less than that of the organic insulating layer in a first area that overlaps the switching elements, the scan lines, and the signal lines in plan view, and
wherein the spacers arranged in the first area have a thickness less than that of the organic insulating layer in the first area.

2. The display device according to claim 1, wherein the spacers are located in positions overlapping the switching elements in plan view.

3. The display device according to claim 1, wherein the spacers are located in positions overlapping the signal lines in plan view.

4. The display device according to claim 1, wherein the spacers are located in positions overlapping the scan lines in plan view.

5. The display device according to claim 1, wherein adjacent two of the spacers are arranged with a space interposed between the spacers.

6. The display device according to claim 1, wherein the spacers have a rectangular or circular sectional shape in plan view.

7. The display device according to claim 1,
wherein the array substrate comprises an orientation film in contact with the liquid crystal layer,
wherein the liquid crystal layer is polymer-dispersed liquid crystals that contain a polymer network formed in a mesh shape and liquid crystal molecules held in a dispersed manner in gaps of the polymer network, and
wherein the orientation film contains a photocrosslinkable group coupled to the polymer network.
